(19) United States
(12) Patent Application Publication
(10) Pub. No.: US 2024/0343142 A1
(43) Pub. Date: Oct. 17, 2024

(54) EXTERNAL COOLANT AND CHARGING SYSTEM

(71) Applicant: TOYOTA MOTOR ENGINEERING & MANUFACTURING NORTH AMERICA, INC., Plano, TX (US)

(72) Inventor: WEILING WANG, Livonia, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-Shi (JP)

(21) Appl. No.: 18/299,485

(22) Filed: Apr. 12, 2023

(51) Int. Cl. B60L 53/302; B60L 53/10; B60L 58/26

(52) U.S. Cl. CPC B60L 53/302; B60L 53/11; B60L 58/26

(57) ABSTRACT

An electric vehicle (EV) charging and cooling system is described that supplies electric power to charge an EV while simultaneously providing coolant to cool the charging components of the EV during the charging process. For example, the system includes a charging device that provides electrical power for charging a battery of the EV. The system also includes a coolant device that transfers coolant to the EV during charging for cooling the battery of the EV. The system also withdraws the coolant from the EV that has been used, and heated to a temperature that may not be suitable for cooling as a result of absorbing heat from the charging components. The system can cool the used coolant back to the cooled temperature to recirculate to the EV throughout a direct current (DC) fast charging process, which provides thermal stability and mitigates damage to the EV from overheating.

### TECHNICAL FIELD

The present disclosure relates generally to electric vehicle technology, such as battery electric vehicles (BEVs). In particular, a system can provide electric recharging and simultaneous cooling of an electric vehicle, which mitigates overheating during the recharging process.

### DESCRIPTION OF RELATED ART

In order to combat negative impacts on the climate and cutting emissions associated with industry, transportation, motorized vehicles, etc., the development of new clean energy technologies has emerged. One such “clean energy” technology is electric vehicles (EVs), where EVs are designed to convert electrical energy (e.g., from a battery) into mechanical energy in a manner that eliminates the cost and unclean emissions related to gasoline fueling. An EV is defined as a vehicle that can be powered by an electric motor that draws electricity from a stored energy source, such as a rechargeable battery or fuel cell, and is capable of being charged from an external source. Some EVs are considered all-electric vehicles, being powered only by an electric motor that draws electricity from a battery. Other EVs are hybrids, where the vehicle can be powered by an electric motor that draws electricity from a battery and is also propelled by an internal combustion engine, such as a plug-in hybrid electric vehicle. EVs may realize a plethora of benefits, in addition to the environmental advantages (e.g., zero tailpipe emissions), including smooth electric performance, energy efficiency, convenience, and lower maintenance costs (e.g., fewer moving parts than gasoline vehicles).

Many EVs have batteries that are energy-dense lithium-ion type batteries. Typically, a bigger battery (measured in kilowatt-hours, or kWh) means more electric range. In general, EVs are cheaper to recharge in comparison to refueling gasoline vehicles. For instance, with every mile of driving, the cost of electricity to recharge an EV is typically a fraction of what that same mile would cost to refuel with gasoline. The battery of an EV can be recharged using an external source, also referred to as a charging station. A charging station (or electric vehicle supply equipment) is a piece of equipment that supplies electrical power for charging plug-in EVs. There are two main types of charging stations: AC charging stations and DC charging stations. Recharging an EV often involves inserting a charging plug from the charging station into the charge port of the EV. For example, the charging plug of the EV can be considered equivalent to a fuel nozzle at a gas station. Electrically recharging EVs provide several benefits over gasoline refueling, such as increased simplicity, cost-effectiveness, and convenience.

### BRIEF SUMMARY OF THE DISCLOSURE

In accordance with an embodiment of the disclosed technology, a system is implemented that includes a charging device that provides electrical power for charging an electric vehicle (EV). Additionally, providing electrical power to the EV produces heat during charging. The system also includes a coolant device that transfers liquid coolant to the EV during charging for cooling the heat at the EV.

In accordance with an embodiment of the disclosed technology, a system includes an EV charger that provides electrical power to charge an EV. Providing the electrical power can involve one or more charging components of the EV such that heat is produced during charging. The system also includes a coolant exchanger that analyzes temperature monitoring data from the EV to determine whether the heat produced during charging is within a threshold of overheating limits. The coolant exchanger can control the transfer of coolant (e.g., liquid-based coolant or gas-based coolant) to the EV during charging to lower the heat to below the threshold of the overheating limits.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example environment of an electric vehicle (EV) utilizing an EV charging and cooling system, for example, in accordance with an embodiment of the technology disclosed herein.

FIG. 2 depicts an example configuration of an EV charging and cooling system shown in FIG. 1 interfacing with an EV, in accordance with an embodiment of the technology disclosed herein.

FIG. 3 depicts an example vehicle in which the systems and methods disclosed herein may be applied.

FIG. 4 is a schematic representation of an example vehicle with which embodiments of the EV charging and cooling system disclosed herein may be implemented.

FIG. 5 is an example computing component that may be used to implement various features of embodiments described in the present disclosure.

The figures are not exhaustive and do not limit the present disclosure to the precise form disclosed.

### DETAILED DESCRIPTION

Batteries for electric vehicles (EV) work based on the principle of a voltage differential, and at high temperatures, the electrons inside become excited which decreases the difference in voltage between the two sides of the battery. Because batteries, and other electric components that support the EV charging process, are manufactured to work between certain temperature extremes, there is a potential that the battery will stop working if there is no cooling system (or an ineffective cooling system) to keep the EV's components in a functional range. For example, an EV cooling system needs to be able to keep a lithium-ion battery pack in the temperature range of about 20-40° C., as well as keep the temperature difference within the battery to a minimum (e.g., no more than) 5°. If there is a large internal temperature difference, it can lead to issues, such as different charge and discharge rates for each cell, and can further result in the deterioration of battery performance. Potential thermal stability issues, such as capacity degradation, thermal runaway, and fire explosion, could occur if the battery overheats or if there is non-uniform temperature distribution in the battery. Thus, the presence of excess heat during EV charging can be both a vehicle performance issue and a life-threatening safety issue. Accordingly, the disclosed EV charging and cooling system is distinctly designed to improve conventional battery cooling systems that are currently used in the EV industry by suppling electric power charging and coolant simultaneously, which mitigates overheating of the battery and other electrical components during the EV charging process.

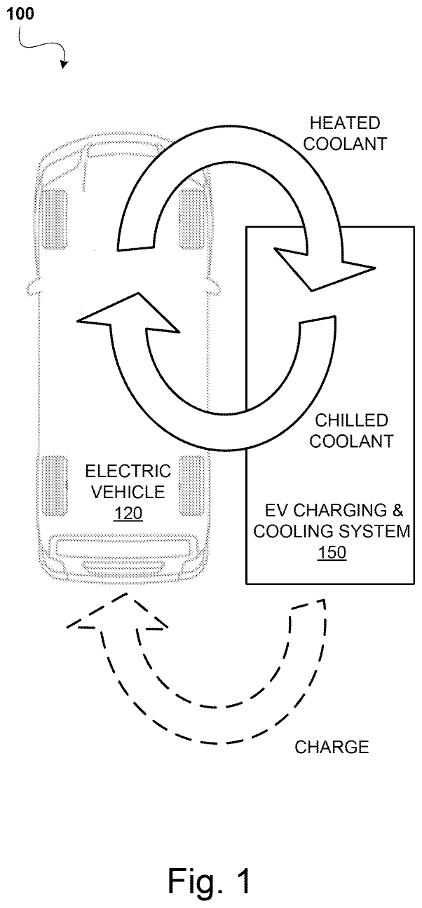

FIG. 1 illustrates an example environment 100 in which a vehicle 120 is interacting with an electric vehicle (EV) charging and cooling system 150, as disclosed herein, for instance during a recharging process. According to the embodiments, the vehicle 120 is an electric vehicle that includes a power storage device, such as a battery, which may require routine recharging in order to continue supplying electrical power to the motor (which propels the vehicle 120). FIG. 1 depicts a recharging process for the EV 120, for instance DC fast charging or DC ultra-fast charging. Employing conventional external charging equipment, such as existing charging stations, in order to conduct the EV's recharging process can provide some benefits, including reduced charging time, and accelerated energy transition. However, it is not uncommon for conventional external charging equipment to generate excess levels of heat during recharging of the EV. Charging an EV involves aspects (e.g., high voltage, converting alternating current (AC) into direct current (DC), direct flow of DC current) where heat is unavoidably produced because of the energy loss, resistance heating, ambient temperatures, and other factors. Prolonged exposure to extreme heat (e.g., while charging) can lead to a wide-range of issues for an EV and its battery health, including but not limited to: overheating of the battery; degrading impact to short- and long-term EV range; slower charging speeds; more energy required for charging; decreased long-term battery capacity; reduced overall battery lifespan; damage to other components and wires; fires; and the like. These problems may be exacerbated in situations where there is frequent recharging of the EV in a short time span, such as repeated fast charging of the EV during long-distance driving. which the more susceptible to heat during charging. Although generating heat during EV recharging is inevitable, the disclosed EV charging and cooling system 150 is distinctly designed with cooling capabilities as a form of thermal management to dissipate excess amounts of heat throughout the charging process. Thus, as the vehicle 120 employs the disclosed EV charging and cooling system 150, the system 150 can provide fast recharging of the battery while simultaneous cooling the EV's charging components (e.g., battery, inverter, charger, etc.) in a manner that prevents internal heat from accumulating and causing substantial harm (e.g., overheat conditions).

FIG. 1 illustrates an example of the general function of the EV charging and cooling system 150 interfacing with the vehicle 120. For instance, the vehicle 120 is plugged into the EV charging and cooling system 150 to conduct a charging process which involves supplying electrical power to the vehicle 120's battery. The EV charging and cooling system 150 may be deployed as a charging station that is located at a designated location, such as a parking garage, mall parking lot, or other public location deemed suitable for EV charging. Accordingly, the EV charging and cooling system 150 can include an EVSE port that provides the power to charge at least one vehicle, and houses one or more power connectors (or plugs) that are compatible to be connected with the vehicle 120. In use, a power connector from the EV charging and cooling system 150 can be plugged into an inlet of the vehicle's 120 charging port (designed to accept the appropriate connector). By coupling the system's 150 connector to the vehicle's 120 charging port, a transfer of electrical power (e.g., DC power) is facilitated which supplies a charge (e.g., shown as dashed line arrow in FIG. 1) to the vehicle's 120 battery. According to the embodiments, the EV charging and cooling system 150 acts a dedicated charging station, which operates in accordance with fast charging and/or DC fast charging standards (e.g., charging rate between 120 kW and 350 kW).

The EV charging and cooling system 150 is distinctly designed to cool the vehicle 120 while simultaneously performing recharging operations. Therefore, in addition to quickly and efficiently charging the vehicle 120, the EV charging and cooling system 150 is also distinctly designed to cool the vehicle 120 in order to maintain thermal stability in the vehicle 120 during charging, in a manner that mitigates overheating. As seen in FIG. 1, the EV charging and cooling system 150 has the capability to flush coolant to the vehicle 120, particularly to cool the vehicle's charging components 120 that are typically active (and may be producing heat) as the vehicle 120 is charging. The EV charging and cooling system 150 is configured to store and refrigerate liquid coolant at substantially low temperatures, for instance 10° C. or lower, in order to transfer the chilled coolant (at the cooled temperature) to the vehicle 120. FIG. 1 illustrates that the EV charging and cooling system 150 has the capability to recirculate coolant with the vehicle 120 (shown as circular arrows in FIG. 1), providing both the transfer of chilled coolant at the lowered temperature to the vehicle 120, and the withdrawal of heated coolant away from the vehicle 120 after its use (e.g., cooling the charging components) where the coolant may be at a higher temperature and needs to be cooled again by the system 150 prior to reuse.

For example, the EV charging and cooling system 150 transfers the chilled coolant at the low temperature to the vehicle 120 (e.g., proximate to the charging port), and circulates the chilled coolant internally (with respect to the vehicle) proximate to the changing components, which allows the substantially low temperatures of the chilled coolant to oppose or counteract the high temperatures of any heat that may be produced by these components during the charging process. Subsequently, after the coolant has absorbed heat away from the charging components, the coolant may become warmed to a temperature where it is no longer suitable for the purposes of cooling the vehicle's 120 charging components, and thus the EV charging and cooling system 150 withdraws the heated coolant away from the vehicle 120. The EV charging and cooling system 150 can accept the heated coolant from the vehicle 120, and refrigerate the coolant until it again reaches the cooled temperature where it can be circulated to the vehicle 120 when needed. Accordingly, FIG. 1 depicts the EV charging and cooling system 150 providing electrical power to recharge the vehicle's 120 battery, and concurrently recirculating coolant to the vehicle 120 to maintain thermal stability and prevent overheating during the fast charging process.

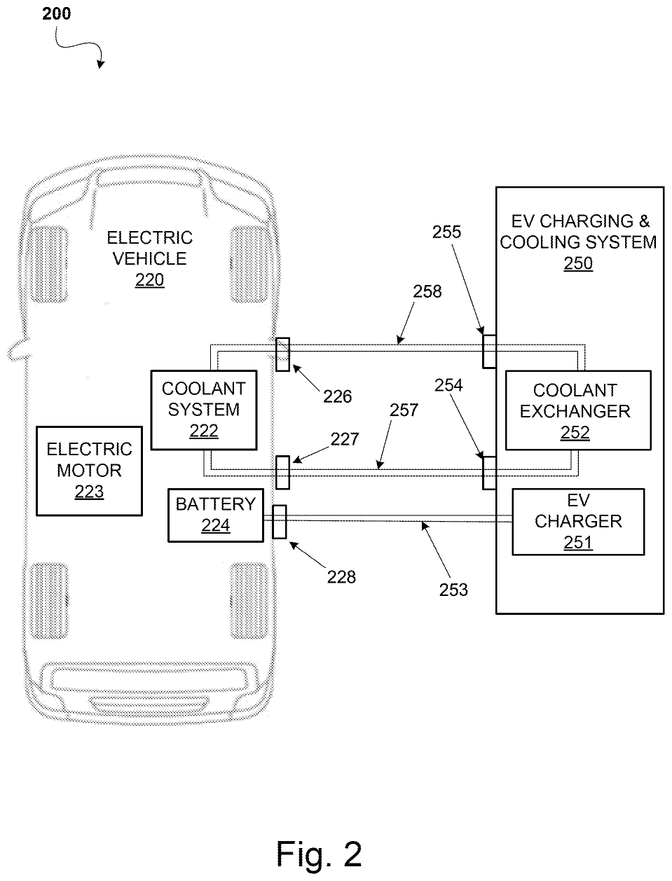

FIG. 2 illustrates another example environment 200, where the disclosed EV charging and cooling system 250 in depicted in greater detail. In FIG. 2, an example configuration of the EV charging and cooling system 250 is illustrated, showing several internal components that can be used to implement the system 250. As seen in FIG. 2, the EV charging and cooling system 250 can be implemented as an EVSE (e.g., EV charging station) having a distinct architecture that comprises: an EV charger 251 configured as the electrical power source which supplies power for charging the vehicle 220; charging connection 253 configured to connect with the vehicle 220 in a manner that facilitates EV charging; a coolant exchanger 252 configured to store, refrigerate, and recirculate (e.g., transfer and withdraw) liquid coolant to/from the vehicle 220; a cooled coolant outlet port 254 and cooled coolant connection 257 configured to connect with the vehicle 220 and facilitate the transfer of chilled coolant out of the system 250 to the vehicle 220; and a heated coolant inlet port 255 and a heated coolant connection 258 configured to withdraw heated coolant from the vehicle 220 to be accepted back into the system 250 for recirculation. It should be appreciated that the configuration for the EV charging and cooling system 250 depicted in FIG. 2 is not intended to be limiting, and the system 250 can include various other components, devices, and sub-systems which are not shown that support the system's 250 described capabilities, where these components can including but not limited to: transformers; filters; electrical disconnects; energy measurement; DC residual current devices (RCD and GFCI); DC contactors and relays, voltage transducer; current measurement (shunt resistor or hall effects); EMC and EMI reduction.

As an operational example, the EV charging and cooling system 250 is connected to the vehicle 220 via the charging connection 253 and is recharging the battery 224 of the vehicle 220, in accordance with DC fast charging standards for instance. Additionally, the EV charging and cooling system 250 is connected to the vehicle 220 via the cooled coolant connection 257 for providing liquid coolant that has been refrigerated (by the coolant exchanger 252) to a defined cooled temperature and transferred to the vehicle 220 for cooling its charging components to maintain thermal stability during EV charging (e.g., DC fast charging). The EV charging and cooling system 250 is also connected to the vehicle 220 via the heated coolant connection 258 for withdrawing liquid coolant away from the vehicle 220 that has been heated after use (by the coolant system 222) to an increased temperature which may no longer be suitable for cooling. After its use, the heated coolant is flushed away from vehicle 220 and accepted back into the system 250 through the heated coolant connection 258, refrigerated again (by coolant exchanger 252) to an acceptable cooled temperature, and recirculated back into the vehicle 220 (through the cooled coolant connection 257) for continued cooling as needed throughout the entirety of the charging process, thereby thwarting the dangers of excess heat during EV charging.

For example, vehicle 220 can be an EV, such as an all-electric vehicle, battery electric vehicle (BEV), hybrid electric vehicle (HEV), plug-in hybrid electric vehicle (PHEVs), and the like. Although the embodiments are described in reference to a personal EV (e.g., light duty vehicle), it should be appreciated that the disclosed features can also be used, where appropriate, with other forms of electric-powered transportation vehicles, such as heavy-duty vehicles (e.g., buses), industrial trucks (e.g., forklifts), and the like. As seen in FIG. 2, the vehicle 220 has various internal components, which include, but are not limited to: an electric motor 223; a battery 224; a charging port 228; a coolant system 222; a vehicle coolant inlet 227; and a vehicle coolant outlet 226. With vehicle 220 implemented as an electric vehicle, the battery 224 can be a high-voltage battery that stores energy received through external charging (e.g., plug-in to system 250), and then provides the stored power to the electric motor 223. The electric motor 223 can use power from the battery 224 to operate and drive the vehicle's 220 wheels. In some implementations, the electric motor 223 can perform both driving and regeneration functions.

As a battery powered electric vehicle, the vehicle 220 uses electricity to power the electric motor 223. For instance, the vehicle 220 produces electricity to power the electric motor 223 by drawing electricity from its charged battery 224. In some implementations, the battery 224 is also used for recapturing braking energy (e.g., regenerative braking). The amount of power and energy stored onboard the vehicle 220 are both closely related to the battery's 224 size. Furthermore, the battery's 224 size and how efficiently it utilizes energy are key factors that contribute to an EV's driving range. Some EVs that are currently available on the market have a driving range of 100 miles on a fully charged battery, while others can reach upwards of 520 miles on a full charge. In other words, as an EV, the size and performance of the battery 224 is essential to the vehicle 220 to achieve peak function. Accordingly, the EV charging and cooling system 250 allows the vehicle 220 to use its plug-in capabilities to charge the battery 224 in a fast and efficient manner (e.g., DC fast charging), while providing thermal stability to ensure that the battery 240 is protected (e.g., from overheating) and can function with optimum efficiency, reliability, and reduced degradation.

FIG. 2 illustrates that the vehicle 220 can be connected to the EV charger 251 of the EV charging and cooling system 250, implementing the EV charging aspects of the system 250. As seen in FIG. 2, the EV charger 251 has a charging connection 253, which may be a charging cable or extension, having a connector at its distal end that can be inserted directly into the charging port 228 of the vehicle 220. As an operational example, the driver of the vehicle 220 can park at the charging station (e.g., the EV charging and cooling system 250) and open its charging port 228. The charging port 228 houses a charging inlet which is configured to accept the connector at the end of the cable 253, when the driver inserts the connector into the charging port 228. The connector for the charging connection 253 may be implemented as a J1772 connector, a Combined Charging System (CCS), CHAdeMO connector, Tesla, or the like, for supporting various EV charging standards. Thus, an EV charging coupling is established with the system 250 by plugging the charging connection 253 (from the EV charger 251) into the charging port 228 of the vehicle 220. This coupling enables the EV charger 251 to distribute electrical power to the vehicle 220 and charge its battery 225, for instance in accordance with DC fast charging standards. In the example of DC fast charging, the EV charger 251 can provide up to 350 kW of power and fully charge an EV, such as vehicle 220, in approximately 15 minutes (providing the EV allows it). In some cases, the EV charger 251 may support other EV charging standards providing a power range from 0 kW to 150 KW, allowing EV charging (up to 80% of capacity) to be completed approximately between 18-30 minutes. In some cases, the vehicle 220 may be equipped with EV charging indicators for the user, for instance having a dashboard light that illuminates as visual notification indicating when the vehicle is in a charging state.

Also, FIG. 2 shows that the vehicle includes a coolant system 222 which is configured to cool the vehicle's charging components. As referred to herein, charging components can be described as vehicle components that are utilized in (or otherwise related to) EV charging of the vehicle which are susceptible to generating, producing, and/or absorbing heat during the charging process. The charging components may be multiple devices on-board the vehicle that are standard for supporting AC charging (e.g., Level 1 charging, Level 2 charging, etc.) and/or DC charging (e.g., Level 3 charging, DC Fast charging, etc.) of the vehicle. FIG. 2 particularly shows the battery 224 and the charging port 228 for vehicle 220, but it should be appreciated that the vehicle 220 can include other charging components that are not depicted such as a charger, converter, inverter, wires, connectors, and the like. Also, FIG. 2 illustrates that the coolant system 222 is placed proximate to the charging components of the vehicle 220, which allows the coolant system 222 to receive coolant (at the cooled temperature) from the EV charging and cooling system 250 and perform its cooling functions to bring down the temperature in that area (e.g., charging environment) of the vehicle 220. In an embodiment, the coolant system 222 implements liquid cooling mechanisms to cool the vehicle's 220 charging components and environment, employing the chilled liquid coolant that is delivered from the EV charging and cooling system 250. In some embodiments, the coolant system 222 implements indirect cooling, similar to ICE cooling systems. With indirect cooling, the coolant system 222 circulates the liquid coolant close to and/or on a surface of, the battery 224 (and other charging components) through a series of channels (e.g., pipes), which transfers away the heat that is emitted by the charging components as the chilled coolant flows over their surface. The coolant system 222 can be structured differently based on the type (and geometry) of the specific EV battery (e.g., car manufacturer) that is utilized by the vehicle 220, in order to achieve maximum temperature uniformity. In some embodiments, the coolant system 222 can employ other cooling mechanisms to supplement its liquid cooling (e.g., coolant) functions, such as air cooling (e.g., convection to transfer heat away from the charging components), fan cooling, phase change cooling, direct liquid cooling, and the like.

In the example of FIG. 2, the EV charging and cooling system 250 includes a coolant exchanger 252. The coolant exchanger 252 can be configured as a storage, refrigeration, and distribution sub-system for the system's 250 coolant. With respect to the refrigeration aspects, the coolant exchanger 252 has the machinery and capability to reduce liquid coolant to a substantially low temperature that is deemed suitable for cooling the charging components of the vehicle 220 during an EV charging process (also referred to herein as the cooled temperature).

In some embodiments, the coolant exchanger 252 handles liquid coolant, where the coolant is a liquid having a degree of heat conductivity and heat capacity (e.g., ability to store heat in the form of energy in its bonds) that is suitable for cooling by transferring heat away from the charging components that are producing heat during the EV charging process, such as the battery 224. For example, the coolant exchanger 252 is configured to utilize various forms of coolant, including but not limited to: glycol-based coolant; ethylene glycol coolant (with additive packages and water); propylene glycol coolant (with water mixture); water; inorganic acid technology (IAT) coolant; organic acid technology (OAT) coolant; hybrid organic acid technology (HOAT) coolant; and the like. The coolant exchanger 252 is also configured to handle gas coolant. For example, the coolant exchanger 252 may store and distribute a gaseous coolant (or gas-based coolant) that has properties that may be suitable for cooling (e.g., thermal conductivity, etc.), such as hydrogen, helium, carbon dioxide, sulfur hexafluoride, and the like. The structure and function of the embodiments described herein are similarly applicable to gas coolant without departing from the scope of the disclosure.

In an embodiment, the refrigeration aspect of the coolant exchanger 252 is implemented as a coolant chiller that is set to chill coolant to a predefined cooled temperature (e.g., approximately 10° C. or lower) or a cooled temperature that is deemed suitable for keeping the charging components within a defined temperature range (e.g., approximately 20°-40° C.). Furthermore, a key function of the coolant exchanger 252 involves re-cooling coolant that has already been used by the vehicle 220. The coolant exchanger 252 can receive heated coolant back from the vehicle 220, and then re-refrigerate the used coolant to ensure that its temperature is lowered to an acceptable cooled temperature before it is recirculated back to the vehicle 220 for continued cooling.

The coolant exchanger 252 is also configured as a coolant storage, which acts a reservoir to safely retain the liquid coolant (until is it exchanged with the vehicle 220) in a thermally stable environment, which maintain the coolant at (or below) the cooled temperature. Additionally, the coolant exchanger 252 is configured with elements that enables the coolant to be exchanged with the vehicle 220, pumping coolant at the cooled temperatures to the vehicle 220 through the cooled coolant outlet port 255. In an embodiment, the cooled coolant outlet port 254 is a mechanical opening mechanism, such as flap, which allows the passage of the liquid coolant from the coolant exchanger 252 as it flows through the cooled coolant connection 257 to the vehicle 220 which is coupled to the vehicle coolant inlet 227 at vehicle 220. Conversely, the coolant exchanger 252 also withdraws coolant from the vehicle 220, by receiving used coolant from the vehicle 220 at heated temperatures through the heated coolant inlet port 255. In an embodiment, the heated coolant inlet port 254 is a mechanical opening mechanism that accepts the liquid coolant into the coolant exchanger 252 as it flows through the heated coolant connection 258 which is coupled to the vehicle coolant outlet 226 at vehicle 220.

The coolant exchanger 252 can also include computer hardware devices, including elements such as processor(s), central processing units(s) (CPU) or controller(s), memory, and the like to implement temperature monitoring and active cooling functions. Temperature monitoring, together with active cooling, can be utilized by the EV charging and cooling system 250 to determine particular actions that optimize thermal stability of the vehicle's 220 charging components during DC fast charging, for example. The coolant exchanger 252 can comprise a processor that is programmed with the instructions to analyze data from monitoring temperatures of the vehicle's 220 charging components (e.g., components involved in the EV charging process). By monitoring the temperature at the vehicle 220 during the course of the EV charging process (e.g., real time), this analysis enables the coolant exchanger 252 to perform active cooling and dynamically determine and/or adjust an amount and/or frequency (e.g., continuously pumping coolant, synchronous/asynchronous time periods for supplying coolant) for providing coolant to the vehicle 220.

Monitoring contact temperature is important in several EV charging standards, such as DC fast charging systems. Thus, the coolant exchanger 252 can receive data associated with monitoring one or more of an EV's charging components throughout charging. For instance, DC charging sensors may be placed at the EV charging contacts (e.g., connectors) which measures a resistance that increases linearly with rising temperature, indicating when the temperature at the contact interface between the vehicle 220 and the EV charging and cooling system 550 is reaching dangerously high temperatures. In the case of AC charging, positive temperature coefficient (PTC) thermistors are used to monitor the temperature at the charging contacts. An HCL interface between the EV and the EVSE is used to communicate the temperature data obtained from the charging components (and ambient area) included in the vehicle's charging port. This temperature data from monitoring may be received and analyzed by the coolant exchanger 252. There are temperature limits that are defined by various EV charging standards, for instance a temperature limit associated with DC fast charging is set such that the temperature for connected contacts does not exceed 50° C. Accordingly, the coolant exchanger 252 can be programmed to start, stop, or adjust the supply of coolant to the vehicle 220 based on the monitored temperatures and the temperature limits set by the EV charging standard being utilized.

As an example, the coolant exchanger 252 may receive data indicating that an ambient temperature at the vehicle's 220 charging components has unexpectedly risen, or an overheating condition is developing. In response, the coolant exchanger 252 is programmed with the capability to dynamically increase the cooling rate, for instance supplying a greater amount of coolant to the vehicle 220 and/or increasing the frequency of supplying coolant to the vehicle 220 (e.g., pumping coolant every minute versus every 10 minutes), in order to prevent the vehicle 220 from exceeding the defined temperature limits for DC fast charging (e.g., ensuring connector contacts temperature remain under 50° C. based on specification limit) and mitigating overheating. In some embodiments, the coolant exchanger 252 performs active cooling such that temperature limits are not reached and actions are triggered when the charging environment are approach temperature limits. Alternatively, the coolant exchanger 252 performs active cooling such that a defined optimal temperature for EV charging is maintained and actions are triggered to keep the charging environment temperature within a threshold of the defined optimal temperature. In some embodiments, the coolant exchanger 252 may be programmed to perform cooling in a more static manner, for instance continuously pumping coolant to the vehicle 220 at a constant rate for the entire duration of the EV charging process, or some variant thereof. According to the embodiments, the coolant exchanger 252 is also configured to trigger other actions for the system 250 in response to potential overheating conditions (e.g., if the temperature increases too much and/or connectors get too hot), for instance triggering the EV charger 251 to slow (e.g., decrease charging rate) or stop the charging process in order to prevent catastrophic overheating of the battery 224 or other charging components.

Referring back to the operational example, the driver of the vehicle 220 can connect the cooled coolant connection 257 (from the system 250), which is implemented as a first cable, to the vehicle coolant inlet 227, and the heated coolant connector 258 (from the system 250) to the vehicle coolant outlet 226, while the vehicle 220 is simultaneously connected to the EV charger 251 (of the system 250) for DC fast charging. After the DC fast charging process has begun, the coolant exchanger 252 can start to pump chilled coolant (at the defined cooled temperature) from the coolant outlet port 254, and flowing through the cooled coolant connection 257 to enter the vehicle 220 through the vehicle coolant inlet 227. The rate of coolant that is supplied to the vehicle 220 may be based on the temperature monitoring, and is dynamically adjustable using the active cooling capabilities of the coolant exchanger 252, as previously described. That is, if the monitored temperature sensed at the charging port 228 decreases to safely below the set temperature limits for DC fast charging, the coolant exchanger 252 may also decrease the rate of coolant in the exchange flow to the vehicle 220 as less coolant may be needed for components already operating at low temperatures. Conversely, if the monitored temperature sensed at the charging port 228 suddenly increases to temperatures that dangerously above the set temperature limits for DC fast charging, the coolant exchanger 252 may also increase the rate of coolant that is pumped to the vehicle 220, as a overheating condition is more eminent with the components running hot during charging. As the chilled coolant flows through the vehicle 220, via the cooling system 222, the coolant eventually becomes heated as it is used to cool the hot charging components (e.g., conducting heat way from the components). This heated coolant then withdrawn from the vehicle 220, where heated coolant flows through the vehicle coolant outlet 226. The heated coolant can pass through the heated coolant connection 258 in order to enter back into the system 250 through the heated coolant inlet port 255. The heated coolant is then cooled once again (to the set cooled temperature) by the coolant exchanger 252. The coolant recirculation process can be repeated by the EV charging and cooling system 250, allowing the coolant to be exchanged between the system 250 and the vehicle 220 as needed to ensure thermal stability of the vehicle's 220 charging components, including the battery 224, until the DC fast charging process is completed. Thus, the EV charging and cooling system 250, as disclosed herein, provides an external EV charging station that also simultaneously exchanges coolant (e.g., cooling the vehicle's 220 charging components) while the vehicle 220 is conducting its EV charging process, thereby mitigating any potential damage to critical EV components that may occur from charge overheating. Additionally, by storing and supplying coolant to the vehicle using an external system, as disclosed herein, the vehicle can avoid expending a substantial amount of its internal energy and/or resources which promotes a maximization of charging efficiency.

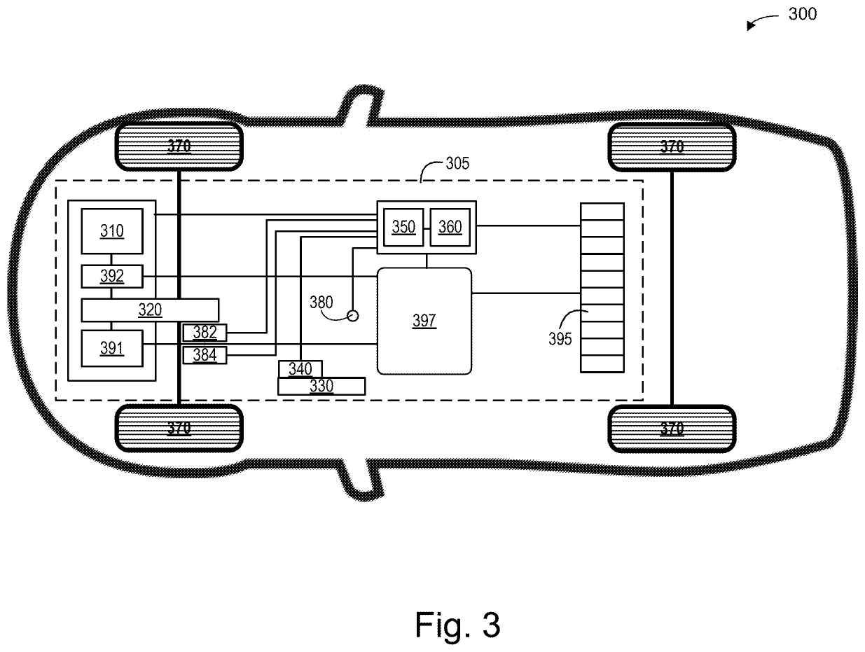

FIG. 3 illustrates an example hybrid electric vehicle (HEV) 300 in which various embodiments for EV charging and cooling, as disclosed herein, are implemented. For example, in one embodiment, the vehicle 120 (shown in FIG. 1) is a HEV 300. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs. Here, HEV 300 includes drive force unit 305 and wheels 370. Drive force unit 305 includes an engine 310, motor generators (MGs) 391 and 392, a battery 395, an inverter 397, a brake pedal 330, a brake pedal sensor 340, a transmission 320, a memory 360, an electronic control unit (ECU) 350, a shifter 380, a speed sensor 382, and an accelerometer 384. Engine 310 primarily drives the wheels 370. Engine 310 can be an ICE that combusts fuel, such as gasoline, ethanol, diesel, biofuel, or other types of fuels which are suitable for combustion. The torque output by engine 310 is received by the transmission 320. MGs 391 and 392 can also output torque to the transmission 320. Engine 310 and MGs 391 and 392 may be coupled through a planetary gear (not shown in FIG. 3). The transmission 320 delivers an applied torque to the wheels 370. The torque output by engine 310 does not directly translate into the applied torque to the wheels 370. MGs 391 and 392 can serve as motors which output torque in a drive mode, and can serve as generators to recharge the battery 395 in a regeneration mode. The electric power delivered from or to MGs 391 and 392 passes through inverter 397 to battery 395. Brake pedal sensor 340 can detect pressure applied to brake pedal 330, which may further affect the applied torque to wheels 370. Speed sensor 382 is connected to an output shaft of transmission 320 to detect a speed input which is converted into a vehicle speed by ECU 350. Accelerometer 384 is connected to the body of HEV 300 to detect the actual deceleration of HEV 300, which corresponds to a deceleration torque.

Transmission 320 is a transmission suitable for an HEV. For example, transmission 320 can be an electronically controlled continuously variable transmission (ECVT), which is coupled to engine 310 as well as to MGs 391 and 392. Transmission 320 can deliver torque output from a combination of engine 310 and MGs 391 and 392. The ECU 350 controls the transmission 320, utilizing data stored in memory 360 to determine the applied torque delivered to the wheels 370. For example, ECU 350 may determine that at a certain vehicle speed, engine 310 should provide a fraction of the applied torque to the wheels while MG 391 provides most of the applied torque. ECU 350 and transmission 320 can control an engine speed (NE) of engine 310 independently of the vehicle speed (V).

ECU 350 may include circuitry to control the above aspects of vehicle operation. ECU 350 may include, for example, a microcomputer that includes a one or more processing units (e.g., microprocessors), memory storage (e.g., RAM, ROM, etc.), and I/O devices. ECU 350 may execute instructions stored in memory to control one or more electrical systems or subsystems in the vehicle. ECU 350 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 391 and 392 each may be a permanent magnet type synchronous motor including for example, a rotor with a permanent magnet embedded therein. MGs 391 and 392 may each be driven by an inverter controlled by a control signal from ECU 350 so as to convert direct current (DC) power from battery 395 to alternating current (AC) power, and supply the AC power to MGs 391, 392. MG 392 may be driven by electric power generated by motor generator MG 391. It should be understood that in embodiments where MG 391 and MG 392 are DC motors, no inverter is required. The inverter, in conjunction with a converter assembly may also accept power from one or more of MGs 391, 392 (e.g., during engine charging), convert this power from AC back to DC, and use this power to charge battery 295 (hence the name, motor generator). ECU 350 may control the inverter, adjust driving current supplied to MG 392, and adjust the current received from MG 391 during regenerative coasting and braking.

Battery 395 may be implemented as one or more batteries or other power storage devices including, for example, lead-acid batteries, lithium ion, and nickel batteries, capacitive storage devices, and so on. Battery 395 may also be charged by one or more of MGs 391, 392, such as, for example, by regenerative braking or by coasting during which one or more of MGs 391, 392 operates as generator. Alternatively (or additionally, battery 395 can be charged by MG 391, for example, when HEV 300 is in idle (not moving/not in drive). Further still, battery 395 may be charged by a battery charger (not shown) that receives energy from engine 310. The battery charger may be switched or otherwise controlled to engage/disengage it with battery 395. For example, an alternator or generator may be coupled directly or indirectly to a drive shaft of engine 310 to generate an electrical current as a result of the operation of engine 310. Still other embodiments contemplate the use of one or more additional motor generators to power the rear wheels of a vehicle (e.g., in vehicles equipped with 4-Wheel Drive), or using two rear motor generators, each powering a rear wheel.

Battery 395 may also be used to power other electrical or electronic systems in the vehicle. Battery 395 can include, for example, one or more batteries, capacitive storage units, or other storage reservoirs suitable for storing electrical energy that can be used to power MG 391 and/or MG 392. When battery 395 is implemented using one or more batteries, the batteries can include, for example, nickel metal hydride batteries, lithium ion batteries, lead acid batteries, nickel cadmium batteries, lithium ion polymer batteries, and other types of batteries.

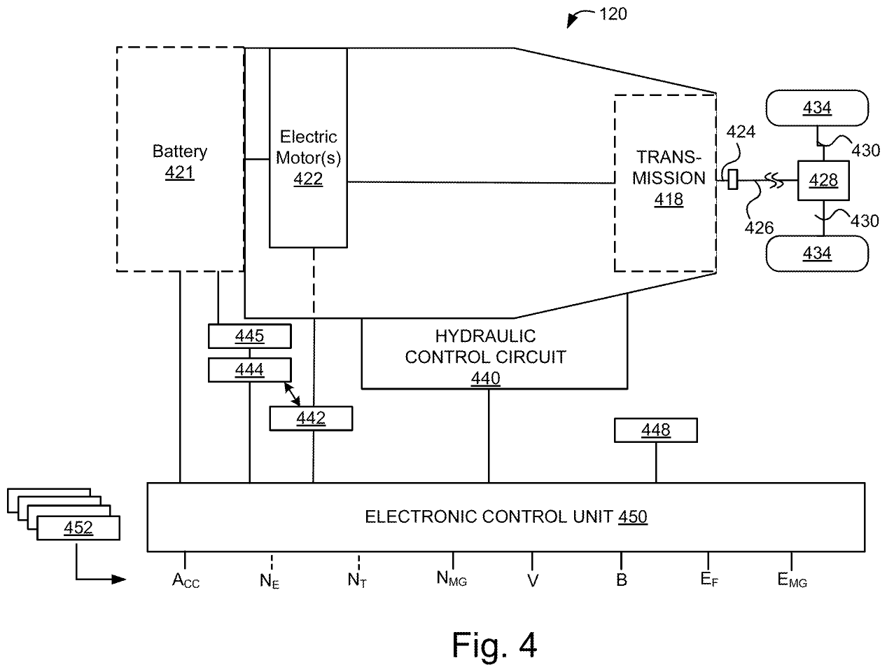

Another example vehicle in which embodiments of the disclosed technology may be implemented is illustrated in FIG. 4. Although the example described with reference to FIG. 1 is described as an full electric vehicle (EV), the disclosed embodiments can be implemented in other types of vehicles including, fuel-cell vehicles, hybrid electric vehicles, or other vehicles.

FIG. 4 illustrates a drive system of an electric vehicle 120, also illustrated in FIG. 1, that may include an EV battery 421, which stores electric powered, and one or more electric motors 422, which receive electric power from the EV battery 421, as sources of motive power. Driving force generated by the electric motors 422 can be transmitted to one or more wheels 434 via, a transmission 418, a differential gear device 428, and a pair of axles 430.

Vehicle 420 may be driven/powered with the electric motor(s) 422 as the drive source for travel. For example, a travel mode may be an EV travel mode that uses the electric motor(s) 422 as the source of motive power. Thus, in EV travel mode, vehicle 120 is powered by the motive force generated by the electric motor 422. In some implementations, another travel mode may be a hybrid electric vehicle (HEV) travel mode that uses the electric motor(s) 422 and an engine (not shown) as the sources of motive power.

As alluded to above, electric motor 422 can be used to provide motive power in vehicle 420 and is powered electrically via a battery 421 (and supplemental battery 444). Battery 421 may be implemented as one or more batteries or other power storage devices including, for example, lead-acid batteries, lithium ion batteries, capacitive storage devices, and so on. Battery 421 may be charged by a battery charger 445. Battery 421 may also be charged by the electric motor 422 such as, for example, by regenerative braking or by coasting during which time motor 422 operate as generator.

Electric motor 422 can be powered by battery 421 to generate a motive force to move the vehicle 420 and adjust vehicle speed. Electric motor 422 can also function as a generator to generate electrical power such as, for example, when coasting or braking. Battery 421 may also be used to power other electrical or electronic systems in the vehicle. Electric motor 422 may be connected to battery 421 via an inverter 442. Battery 421 can include, for example, one or more batteries, capacitive storage units, or other storage reservoirs suitable for storing electrical energy that can be used to power the electric motor 422. When battery 421 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 450 (described below) may be included and may control the electric drive components of the vehicle as well as other vehicle components. For example, electronic control unit 450 may control inverter 442, adjust driving current supplied to electric motor 422, and adjust the current received from electric motor 422 during regenerative coasting and braking As a more particular example, output torque of the electric motor 422 can be increased or decreased by electronic control unit 450 through the inverter 442.

As alluded to above, vehicle 420 may include an electronic control unit 450. Electronic control unit 450 may include circuitry to control various aspects of the vehicle operation. Electronic control unit 450 may include, for example, a microcomputer that includes a one or more processing units (e.g., microprocessors), memory storage (e.g., RAM, ROM, etc.), and I/O devices. The processing units of electronic control unit 450, execute instructions stored in memory to control one or more electrical systems or subsystems in the vehicle. Electronic control unit 450 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS, ESC, or regenerative braking system), battery management systems, and so on. These various control units can be implemented using two or more separate electronic control units or using a single electronic control unit.

In the example illustrated in FIG. 4, electronic control unit 450 receives information from a plurality of sensors included in vehicle 420. For example, electronic control unit 450 may receive signals that indicate vehicle operating conditions or characteristics, or signals that can be used to derive vehicle operating conditions or characteristics. These may include, but are not limited to accelerator operation amount, ACC, a revolution speed, NE, rotational speed, NMG, of the motor 422 (motor rotational speed), and vehicle speed, NV. These may also include NT (e.g., output amps indicative of motor output), brake operation amount/pressure, B, battery SOC (i.e., the charged amount for battery 421 detected by an SOC sensor). Accordingly, vehicle 420 can include a plurality of sensors 452 that can be used to detect various conditions internal or external to the vehicle and provide sensed conditions to engine control unit 450 (which, again, may be implemented as one or a plurality of individual control circuits). In one embodiment, sensors 452 may be included to detect one or more conditions directly or indirectly such as, for example, fuel efficiency, EF, motor efficiency, EMG, hybrid (internal combustion engine 14+MG 12) efficiency, acceleration, ACC, etc.

Additionally, the one or more sensors 452 can be configured to detect, and/or sense position and orientation changes of the vehicle 420, such as, for example, based on inertial acceleration. In one or more arrangements, the electronic control unit 450 can obtain signals from vehicle sensor(s) including accelerometers, one or more gyroscopes, an inertial measurement unit (IMU), a dead-reckoning system, a global navigation satellite system (GNSS), a global positioning system (GPS), a navigation system, and/or other suitable sensors. In one or more arrangements, the electronic control unit 50 receives signals from a speedometer to determine a current speed of the vehicle 420.

In some embodiments, one or more of the sensors 452 may include their own processing capability to compute the results for additional information that can be provided to electronic control unit 450. In other embodiments, one or more sensors may be data-gathering-only sensors that provide only raw data to electronic control unit 450. In further embodiments, hybrid sensors may be included that provide a combination of raw data and processed data to electronic control unit 450. Sensors 452 may provide an analog output or a digital output. Additionally, as alluded to above, the one or more sensors 452 can be configured to detect, and/or sense in real-time. As used herein, the term “real-time” means a level of processing responsiveness that a user or system senses as sufficiently immediate for a particular process or determination to be made, or that enables the processor to keep up with some external process.

Sensors 452 may be included to detect not only vehicle conditions but also to detect external conditions as well. Sensors that might be used to detect external conditions can include, for example, sonar, radar, lidar or other vehicle proximity sensors, and cameras or other image sensors. In some embodiments, cameras can be high dynamic range (HDR) cameras or infrared (IR) cameras. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. Accordingly, the one or more sensors 452 can be configured to acquire, and/or sense driving environment data. For example, environment sensors can be configured to detect, quantify and/or sense objects in at least a portion of the external environment of the vehicle 420 and/or information/data about such objects. Such objects can be stationary objects and/or dynamic objects. Further, the sensors can be configured to detect, measure, quantify and/or sense other things in the external environment of the vehicle 420, such as, for example, lane markers, signs, traffic lights, traffic signs, lane lines, crosswalks, curbs proximate the vehicle 420, off-road objects, etc.

Sensors 452 may be included to detect not only vehicle conditions but also to detect external conditions as well. Sensors that might be used to detect external conditions can include, for example, sonar, radar, lidar or other vehicle proximity sensors, and cameras or other image sensors. In some embodiments, cameras can be high dynamic range (HDR) cameras or infrared (IR) cameras. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. Accordingly, the one or more sensors 452 can be configured to acquire, and/or sense driving environment data. For example, environment sensors can be configured to detect, quantify and/or sense objects in at least a portion of the external environment of the vehicle 420 and/or information/data about such objects. Such objects can be stationary objects and/or dynamic objects. Further, the sensors can be configured to detect, measure, quantify and/or sense other things in the external environment of the vehicle 420, such as, for example, lane markers, signs, traffic lights, traffic signs, lane lines, crosswalks, curbs proximate the vehicle 420, off-road objects, etc.

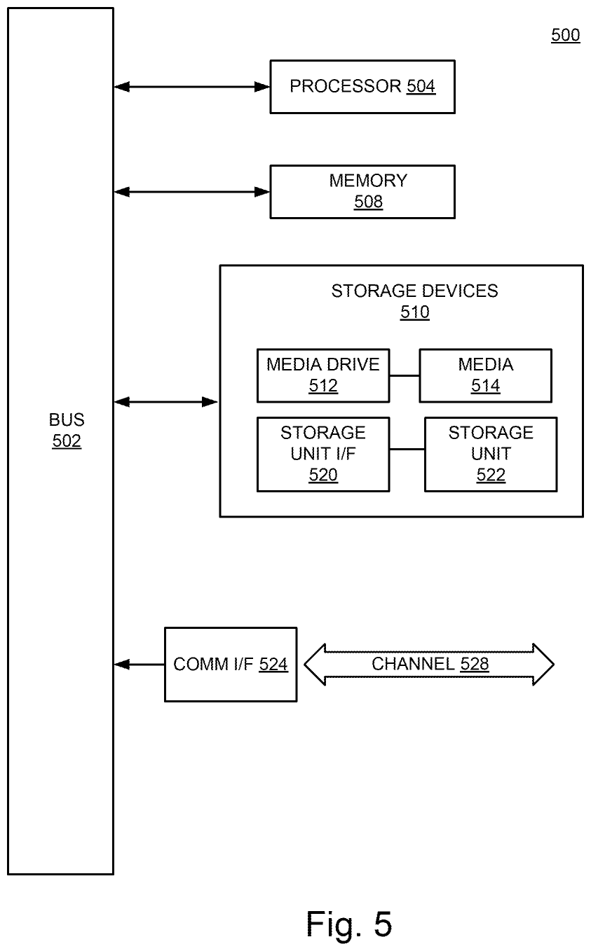

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 400 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor 504. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to, or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a charging device providing electrical power for charging a vehicle, wherein providing the electrical power produces heat during charging; and
a coolant device transferring coolant to the vehicle during charging for cooling the heat at the vehicle.

2. The system of claim 1, wherein the charging device provides electrical power to charge a battery of the vehicle and the battery produces heat.

3. The system of claim 2, wherein the coolant device comprises a coolant chiller for cooling the coolant to a cooled temperature.

4. The system of claim 3, comprising a cooled coolant connection to the vehicle wherein the coolant device transfers the coolant at the cooled temperature to the vehicle through the cooled coolant connection.

5. The system of claim 4, wherein the coolant conducts the heat from the battery and increases from the cooled temperature to a heated temperature.

6. The system of claim 5, comprising a heated coolant connection to the vehicle wherein the coolant device withdraws the coolant at the heated temperature from the vehicle through the heated coolant connection.

7. The system of claim 6, wherein the coolant device receives the coolant at the heated temperature and the coolant chiller cools the coolant to the cooled temperature.

8. The system of claim 7, wherein the coolant device recirculates the coolant at the cooled temperature back to the vehicle during charging.

9. The system of claim 1, wherein the charging device provides the electrical power to the vehicle in accordance with direct current (DC) fast charging.

10. A system comprising:
a charger providing electrical power to charge a vehicle, wherein providing the electrical power involves one or more charging components of the vehicle such that heat is produced during charging; and
a coolant exchanger analyzing temperature monitoring data from the vehicle to determine whether the heat produced during charging is within a threshold of overheating limits, and controlling the transfer of coolant to the vehicle during charging to lower the heat to below the threshold of the overheating limits.

11. The system of claim 10, wherein the coolant exchanger transfers the coolant at a cooled temperature to the vehicle.

12. The system of claim 11, wherein the coolant conducts the heat from the one or more charging components and increases from the cooled temperature to a heated temperature.

13. The system of claim 12, wherein the coolant exchanger receives the coolant at the heated temperature and cools the coolant to the cooled temperature to recirculate to the vehicle during charging.

14. The system of claim 10, wherein the coolant exchanger controls the transfer of coolant to the vehicle by adjusting a rate of transferring the coolant to the vehicle based on the temperature monitoring data.

15. The system of claim 10, wherein the coolant comprises liquid coolant or gas coolant.
